(19) United States
(12) Patent Application Publication
(10) Pub. No.: US 2026/0084280 A1
(43) Pub. Date: Mar. 26, 2026

(54) ELECTRIC POWER TOOL

(71) Applicant: TECHTRONIC CORDLESS GP, Anderson, SC (US)

(72) Inventors: Ping Li, Dongguan City (CN); Fa Ji Luo, Dongguan City (CN); Zheng Zheng Zhang, Dongguan City (CN)

(21) Appl. No.: 19/337,069

(22) Filed: Sep. 23, 2025

(30) Foreign Application Priority Data
Sep. 23, 2024 (DE) 202024105462.8

(51) Int. Cl. B25F 5/02; B24B 23/02

(52) U.S. Cl. CPC B25F 5/02; B24B 23/028

(57) ABSTRACT

An electric power tool includes an effector and an operating switch for setting an operating state of the effector. In a first switch position, the operating switch sets a first operating state of the effector in which the effector is deactivated, and in a second switch position, the operating switch sets a second operating state of the effector in which the effector is activated and a movement of the switch element of the operating switch in at least two dimensions is required to change the operating switch from the first switch position to the second switch position.

### CROSS-REFERENCE TO RELATED APPLICATIONS

This application claims priority under 35 U.S. C. § 119 to German Utility Model Application No. DE 20 2024 105 462.8, filed Sep. 23, 2024, the entire content of which is incorporated by reference herein.

### FIELD

The present invention relates to an electric power tool, and particularly an electric power tool with an improved operating switch.

### BACKGROUND

Generally electric power tools, and particularly handheld battery-powered electric power tools, are well-known. For electric power tools, protection from accidental activation is desirable. At the same time, simple handling during operation of the electric power tool is desirable.

### SUMMARY

The present disclosure provides, in one aspect, an electric power tool including: an effector; and an operating switch for setting an operating state of the effector; wherein in a first switch position, the operating switch sets a first operating state of the effector, and in a second switch position, the operating switch sets a second operating state of the effector, in the first operating state, the effector is deactivated, and in the second operating state, the effector is activated, and a movement of a switch element of the operating switch in at least two dimensions is required to change the operating switch from the first switch position to the second switch position.

The present disclosure provides, in another aspect, ab electric power tool including: a housing having a surface; an effector; and an operating switch for setting an operating state of the effector, the operating switch including a switch element coupled to a contact element by a connecting element, the switch element having a locking element, and a locking protrusion protruding from a surface of the electric power tool, the locking protrusion engageable with the locking element to block translation of the switch element.

The present disclosure provides, in another aspect, an electric power tool including: an effector; and an operating switch movable between a first switch position and a second switch position, wherein the effector is deactivated when the operation switch is in the first switch position, wherein the effector is activated when the operation switch is in the second switch position, and wherein the operating switch is movable in two dimensions and movement of the operation switch in only one dimension does not move the operating switch from the first position to the second position.

Other features and aspects of the invention will become apparent by consideration of the following detailed description and accompanying drawings.

### BRIEF DESCRIPTION OF THE DRAWINGS

FIG. 1 is a perspective view of an electric power tool.

FIG. 2a is a side view illustrating an operation switch of the electric power tool.

FIG. 2b is a section view of the operating switch of the electric power tool along line B-B in FIG. 2a.

FIG. 3a is a side view of an operation switch of the electric power tool of FIG. 1.

FIG. 3b is a side view of the operation switch of FIG. 3a with a tilted switch element.

FIG. 3c is a side section view of the operation switch of FIGS. 3a and 3b in a second switch position.

Before any embodiments of the subject matter are explained in detail, it is to be understood that the subject matter is not limited in its application to the details of construction and the arrangement of components set forth in the following description or illustrated in the following drawings. The subject matter is capable of other embodiments and of being practiced or of being carried out in various ways. Also, it is to be understood that the phraseology and terminology used herein is for the purpose of description and should not be regarded as limiting.

### DETAILED DESCRIPTION

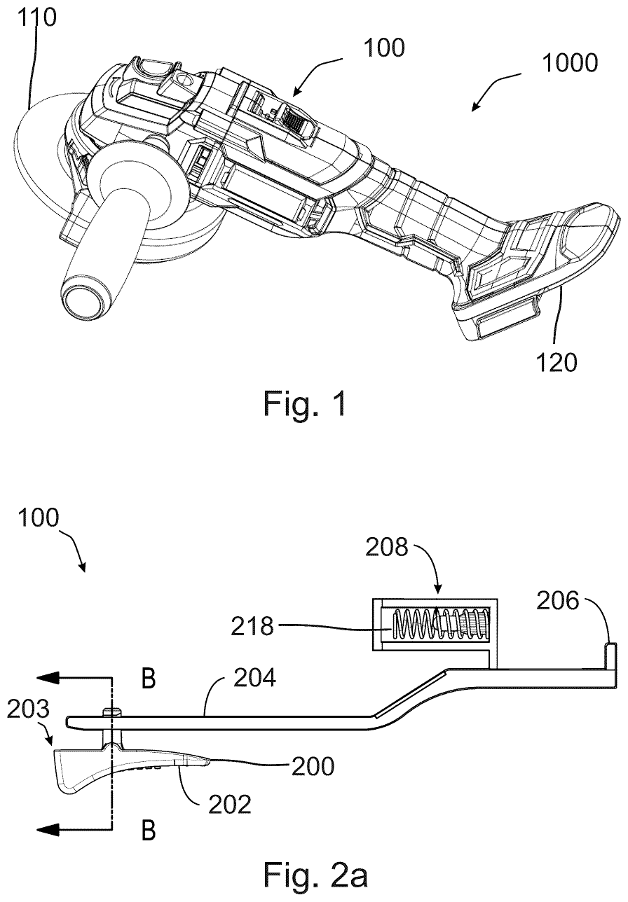

FIG. 1 shows an electric power tool 1000, particularly a battery-powered angle grinder. The electric power tool 1000 includes an operation switch 100. The electric power tool 1000 includes an effector 110 and a battery mount 120. The operation switch 100 is arranged on a side of the electric power tool facing away from the effector 110. The electric power tool 1000 extends substantially along a centerline between the effector 110 and the battery mount 120.

Along the centerline, the operation switch 100 is arranged between the effector 110 and the battery mount 120.

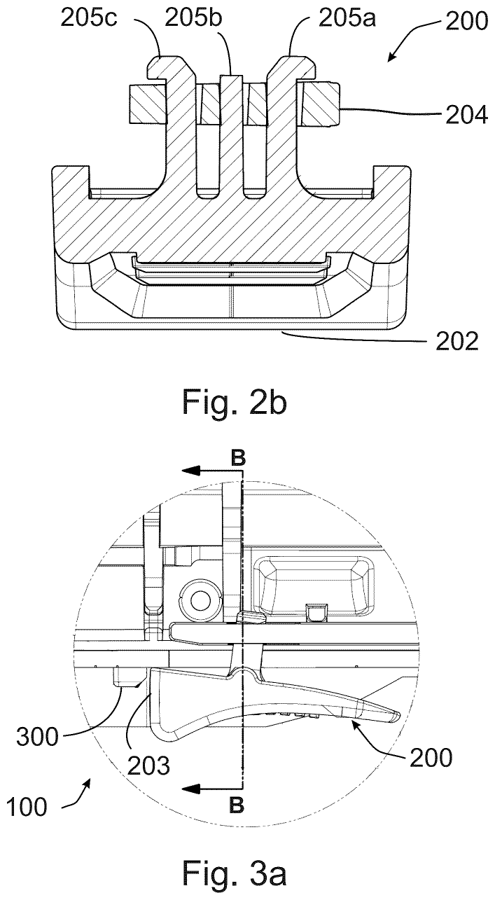

The operation switch 100 of the electric power tool 1000 is schematically shown in FIG. 2a. The operation switch 100 includes a switch element 200. The switch element 200 includes a contact surface 202. The contact surface 202 is configured to accept a finger of the operator. Particularly, the contact surface 202 has a surface structure, such as corrugations, to facilitate operation of the switch element 200 by the operator. The contact surface 202 of the switch element 200 in a longitudinal section substantially follows the shape of a human finger in a longitudinal section. Particularly, the contact surface 202 has a curved shape in a longitudinal section. The switch element 200 typically includes a locking element 203 which is arranged substantially perpendicular to a centerline of the contact surface 202. Collectively, the switch element 200 follows an L-shape or hook shape in longitudinal cross-section, as illustrated in FIG. 2a.

The switch element 200 is mechanically connected to a contact element 206 with connecting element 204. The contact element 206 causes a change in the electrical connection (not shown in FIG. 2a), particularly the electrical connection is changed depending on the position of the operation switch 100, and particularly depending on the position of the switch element 200, e.g. open or closed.

The operation switch 100 includes an elastic element 208. The elastic element 208 acts against a movement of the switch element 200 in at least one dimension. In FIG. 2a, the elastic element 208 acts against a movement of the switch element 200 to the left, for example into a switch position associated with an activated effector. The elastic element includes a spring 218.

In FIG. 2b, the connection of the switch element 200 with the connecting element 204 is illustrated in cross-section along the section line B of FIG. 2a. The switch element 200 engages with openings of the connecting element 204 with pins 205a-c. The pins 205a-c may at least partially be an L-shape, particularly to prevent removal or loss of the switch element 200. The pins 205a-c and the switch element 200 are typically configured such that a tilting of the switch element, at least within a predetermined angular range, is possible.

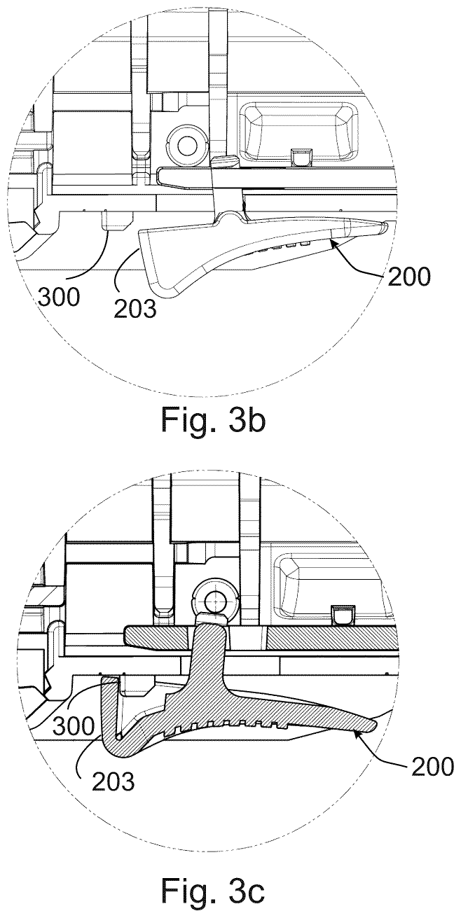

In FIG. 3a, a switch element 200 in an installed position is illustrated. The switch element 200 is located in the first switch position. The first switch position is typically associated with a first operation state of the electric power tool, particularly with a deactivated operation state of the effector. The operation switch 100 includes a locking protrusion 300. The locking protrusion 300 protrudes from the contour of the surface of the electric power tool and is arranged between the first and the second switch position. In longitudinal section, the locking protrusion 300 has a chamfered contact surface towards the first switch position and a rounded contact surface towards the second switch position.

In the first switch position, as shown in FIG. 3a, the switch element 200 is arranged such that the first end of the locking element 203 is located nearer to the centerline of the electric power tool than the first end of the locking protrusion 300. A movement of the switch element 200 in the direction of the locking protrusion 300, and particularly into the second switch position, is therefore mechanically blocked by the locking protrusion 300.

FIG. 3b shows the switch element 200 of FIG. 3a in the first switch position and in a tilted state. In the tilted state, the switch element 200 is tilted about a rotation axis in the connecting element 204. In the tilted state in the first switch position, the switch element 200 is tilted so that the first end of the locking element 203 is located farther from the centerline of the electric power tool than the locking protrusion 300. Accordingly, a movement of the switch element 200 in the direction of the locking protrusion 300, and particularly into the second switch position, is no longer mechanically blocked by the locking protrusion 300.

In FIG. 3c, the switch element 200 of FIG. 3b is translated in the direction of the locking protrusion 300, and therefore in the direction of the second switch position. In FIG. 3c, the switch element is oriented such that the first end of the locking element 203 is located nearer to the centerline of the electric power tool than the first end of the locking protrusion 300.

Accordingly, a movement of the switch element 200 in the direction of the locking protrusion 300, and particularly in the direction of the first switch position, is mechanically blocked by the locking protrusion 300. To return the switch element 200 into the first switch position, the switch element 200 may be tilted again, similarly to the illustration of FIG. 3b.

Although specific embodiments have been shown and described herein, it is within the scope of the present invention to suitably modify the embodiments shown without departing from the scope of protection of the present invention.

What is claimed is:

1. An electric power tool comprising:
an effector; and
an operating switch for setting an operating state of the effector;
wherein in a first switch position, the operating switch sets a first operating state of the effector, and in a second switch position, the operating switch sets a second operating state of the effector,
in the first operating state, the effector is deactivated, and in the second operating state, the effector is activated, and
a movement of a switch element of the operating switch in at least two dimensions is required to change the operating switch from the first switch position to the second switch position.

2. The electric power tool according to claim 1, wherein the operating switch is lockable in the first switch position.

3. The electric power tool according to one of claims 1 and 2, wherein the operating switch is lockable in the second switch position.

4. The electric power tool according to claims 1, wherein a movement of the switch element along a centerline of the electric power tool and a movement perpendicular to the centerline of the electric power tool are required for changing the operating switch from the first switch position to the second switch position.

5. The electric power tool according to claim 4, wherein changing the operating switch from the first switch position to the second switch position comprises a first movement of the operating switch perpendicular to the centerline of the electric power tool, a second movement of the operating switch along the centerline of the electric power tool, and a third movement of the operating switch opposite to the first movement.

6. The electric power tool according to claims 1, wherein a movement of the switch element along a centerline of the electric power tool and a tilting of the switch element is required to change the operating switch from the first switch position to the second switch position.

7. The electric power tool according to claim 6, wherein changing the operating switch from the first switch position to the second switch position comprises a first tilting of the switch element about an axis of the switch element perpendicular to the centerline of the electric power tool, a second movement of the switch element along the centerline of the electric power tool, and a third tilting of the switch element opposite to a direction of the first tilting.

8. The electric power tool according to claim 1, wherein a movement of the switch element in one dimension is required to change the operating switch from the second switch position to the first switch position, and a subsequent movement to the first switch position is performed by an elastic element of the operating switch.

9. The electric power tool according to claim 8, wherein the elastic element comprises a spring.

10. The electric power tool according to claims 1, wherein the operating switch is arranged at a side of the electric power tool facing away from the effector.

11. The electric power tool according to one of claims 1, wherein the electric power tool is battery-powered.

12. The electric power tool according to claims 1 wherein the electric power tool is an abrasive cut-off tool.

13. The electric power tool according to claims 1, wherein the electric power tool is an angle grinder.

14. An electric power tool comprising:
a housing having a surface;
an effector; and
an operating switch for setting an operating state of the effector, the operating switch including
a switch element coupled to a contact element by a connecting element, the switch element having a locking element, and
a locking protrusion protruding from a surface of the electric power tool, the locking protrusion engageable with the locking element to block translation of the switch element.

15. The electric power tool of claim 14, wherein the connecting element defines one or more openings, and the switch element includes one or more corresponding pins positioned in the one or more openings.

16. The electric power tool of claim 15, wherein the pins have an L-shape to prevent removal or loss of the switch element.

17. The electric power tool of claim 14, wherein the operation switch is arranged on a side of the power tool facing away from the effector.

18. The electric power tool of claim 14, wherein the operation switch is movable between a first switch position and a second position.

19. The electric power tool of claim 14, wherein the locking element is arranged perpendicular to a centerline of the electric power tool.

20. An electric power tool comprising:
an effector; and
an operating switch movable between a first switch position and a second switch position,
wherein the effector is deactivated when the operation switch is in the first switch position,
wherein the effector is activated when the operation switch is in the second switch position, and
wherein the operating switch is movable in two dimensions, such that movement of the operation switch in only one dimension does not move the operating switch from the first position to the second position.
